(19) United States
(12) Patent Application Publication
(10) Pub. No.: US 2022/0332538 A1
(43) Pub. Date: Oct. 20, 2022

(54) SPLIT SPOOL ASSEMBLY FOR A THREE-DIMENSIONAL PRINTER

(71) Applicant: Essentium, Inc., Pflugerville, TX (US)

(72) Inventors: Petrus Ioan, Fullerton, CA (US); Erik John Gjovik, Aliso Viejo, CA (US)

(21) Appl. No.: 17/835,569

(22) Filed: Jun. 8, 2022

Related U.S. Application Data
(63) Continuation of application No. PCT/US20/19245, filed on Feb. 21, 2020.
(60) Provisional application No. 62/945,620, filed on Dec. 9, 2019.

(51) Int. Cl. B65H 75/14; B29C 64/307

(52) U.S. Cl. CPC B65H 75/14; B29C 64/307; B65H 2701/5114; B33Y 40/00

(57) ABSTRACT

A split spool assembly for discharging filament to a three-dimensional printer is provided. The assembly includes a first spool part having a first reel collar angularly spaced from an axis and a first hub portion, which is disposed about the axis and angularly spaced from the first reel collar. The assembly further includes a second spool part having a second reel collar angularly spaced from the axis and a second hub portion, which is disposed about the axis and angularly spaced from the second reel collar. The first and second collars are spaced from one another for storing a predetermined amount of filament therebetween. The first and second hub portions are disposed about the axis and terminate at associated first and second ends, with the first and second ends being positioned adjacent to one another such that the first and second hub portions are arranged in series along the axis.

### CROSS-REFERENCE TO RELATED APPLICATION

The subject patent application claims priority to and all the benefits of U.S. Provisional Patent Application No. 62/945,620 which was filed on Dec. 9, 2019, the disclosure of which is hereby incorporated by reference in its entirety.

### TECHNICAL FIELD

The present disclosure relates to three-dimensional (3D) printers, and more particularly to a split spool assembly for dispensing 3D filament to one or more 3D printers.

### BACKGROUND

The statements in this section merely provide background information related to the present disclosure and may or may not constitute prior art.

Three-dimensional printers form three dimensional objects from computer generated models. In some instances, the printers deposit a feed stock in an additive manufacturing process. The feed stock may be deposited utilizing a printer head, which draws the feedstock, such as a thermoplastic filament, from a spool contained within a cannister. The printer head may move in a three-dimensional path while heating and depositing the feedstock to form the object. For example, the printer head may deposit the feedstock in a first layer and then, either the printer head, or the support table, may be moved to form successive layers. This process may then be repeated until the object is completed.

A number of challenges arise in the printing of objects using conventional spools for three-dimensional printers. One challenge in the printing process is that the supply of filament on a spool can be quickly exhausted when, for example, the printer is utilized for printing large objects. Another challenge is that empty spools without filament may not nest with one another to efficiently utilize available storage space.

Thus, while current spools achieve their intended purpose, there is a need for a new and improved split spool assembly and methods for manufacturing the same to increase the amount of filament stored on and dispensed from the spool assembly and permit empty spool assemblies to be nested with one another for efficient packaging and storage.

### SUMMARY

The present disclosure provides a split spool assembly for discharging filament to a three-dimensional printer. The split spool assembly includes a first spool part having a first reel collar angularly spaced from an axis and a first hub portion, which is disposed about the axis and angularly spaced from the first reel collar. The split spool assembly further includes a second spool part having a second reel collar angularly spaced from the axis and a second hub portion, which is disposed about the axis and angularly spaced from the second reel collar. The first and second reel collars are spaced from one another by a width for storing a predetermined amount of filament therebetween. The first and second hub portions are disposed about the axis and terminate at associated first and second ends, with the first and second ends being positioned adjacent to one another such that the first and second hub portions are arranged in series along the axis. A combined length of the first and second hub portions provides the width between the first and second reel collars for supporting the filament wound around the first and second hub portions.

The present disclosure also provides a three-dimensional printer includes an enclosure that defines a chamber. The printer further includes a work surface disposed within the chamber and a hozzle for melting and dispensing a filament within the chamber. The printer further includes one or more canisters containing a split spool assembly for storing the filament. The printer further includes a filament drive system for engaging the filament and drawing the filament from the canisters, with the hozzle receiving the filament from the filament drive system. The split spool assembly includes a first spool part having a first reel collar angularly spaced from an axis and a first hub portion, which is disposed about the axis and angularly spaced from the first reel collar. The split spool assembly further includes a second spool part having a second reel collar angularly spaced from the axis and a second hub portion, which is disposed about the axis and angularly spaced from the second reel collar. The first and second reel collars are spaced from one another by a width for storing a predetermined amount of filament therebetween. The first and second hub portions are disposed about the axis and terminate at associated first and second ends, with the first and second ends being positioned adjacent to one another such that the first and second hub portions are arranged in series along the axis. A combined length of the first and second hub portions provides the width between the first and second reel collars for supporting the filament wound around the first and second hub portions.

The present disclosure also provides a method for manufacturing a split spool assembly including first and second spool parts. The first and second spool parts have associated first and second reel collars angularly spaced from an axis and first and second hub portions disposed about the axis. The method includes placing a flat sheet metal into a stamping press and drawing the first and second hub portions from the sheet metal. The first and second reel collars are cut from the flat sheet metal, and the first and second hub portions are positioned adjacent to one another, such that the first and second hub portions are arranged in series along the axis and a combined length of the first and second hub portions provides a width between the first and second reel collars. The first and second hub portions are connected to one another, and filament is wound around the first and second hub portions.

Other features and advantages of the present disclosure will be readily appreciated, as the same becomes better understood, after reading the subsequent description taken in conjunction with the accompanying drawings.

### DRAWINGS

Advantages of the present disclosure will be readily appreciated as the same becomes better understood by reference to the following detailed description when considered in connection with the accompanying drawings.

FIG. 1 is a perspective partially cutaway view of a 3D printer, illustrating the 3D printer having multiple canisters for storing and discharging a filament.

FIG. 2 is a perspective view of one of the canisters of FIG. 1.

FIG. 3 is a perspective view of a split spool assembly contained within the cannister of FIG. 2, illustrating the assembly having first and second spool parts for storing and discharging the filament.

FIG. 4 is a perspective view of the spool assembly of FIG. 3, illustrating the first and second spool parts connected to one another.

FIG. 5 is an end view of the assembly of FIG. 4.

FIG. 6 is an end view of one of the spool parts of FIG. 4.

FIG. 7 is an exploded side view of the split spool assembly of FIG. 4, illustrating the first and second spool parts spaced from one another.

FIG. 8 is an enlarged cross-sectional view of the first spool part of FIG. 5, illustrating the first spool part having a rolled lip edge.

FIG. 9 is a perspective view of a stack of the first and second spool parts nested with one another for storing or transporting the same.

FIG. 10 is a cross-sectional view of the stack of FIG. 9 as taken along line 10-10.

FIG. 11 is a flow chart for a method of manufacturing the spool assembly of FIG. 2.

### DETAILED DESCRIPTION

The following description is merely exemplary in nature and is not intended to limit the present disclosure, application, or uses.

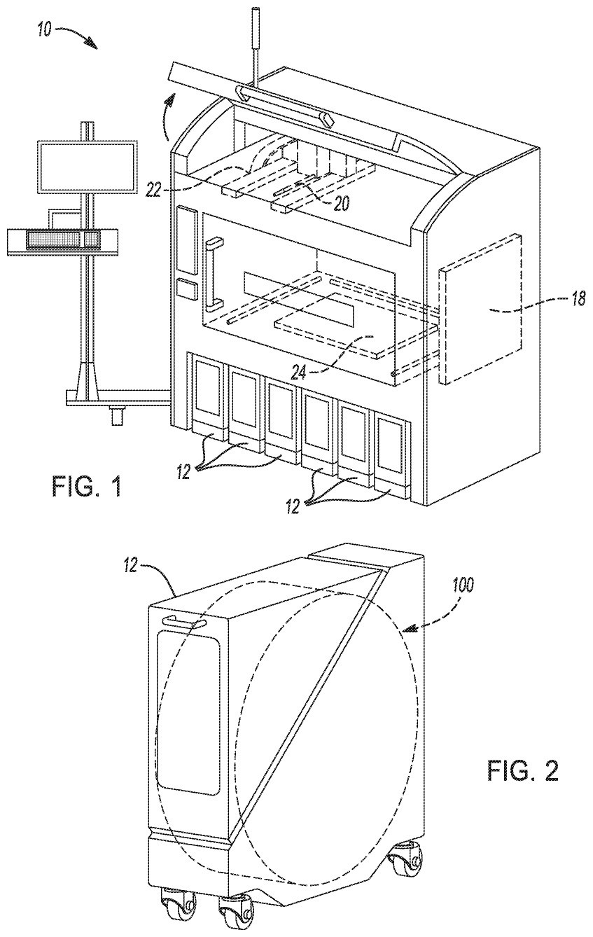

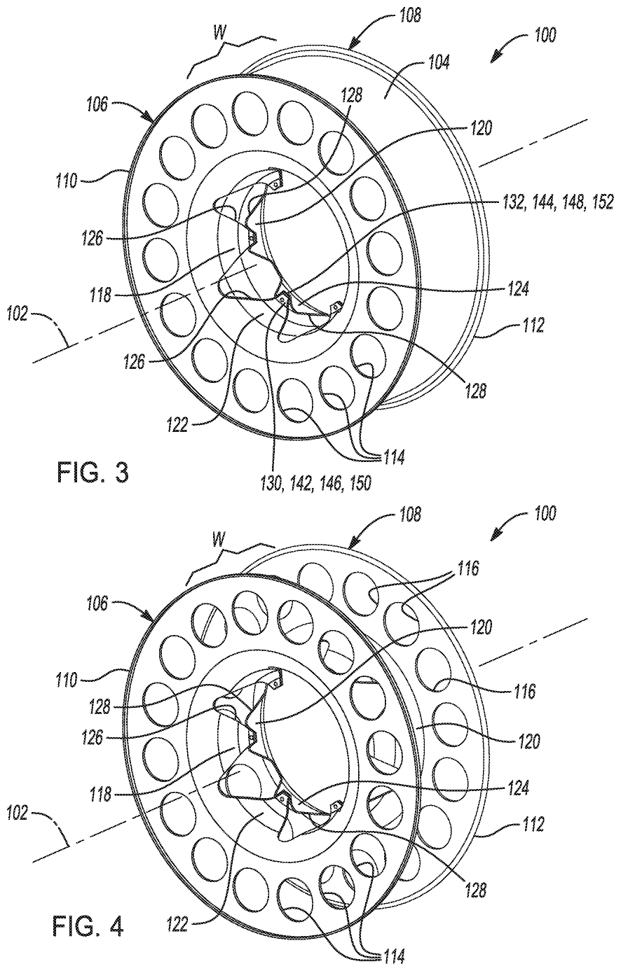

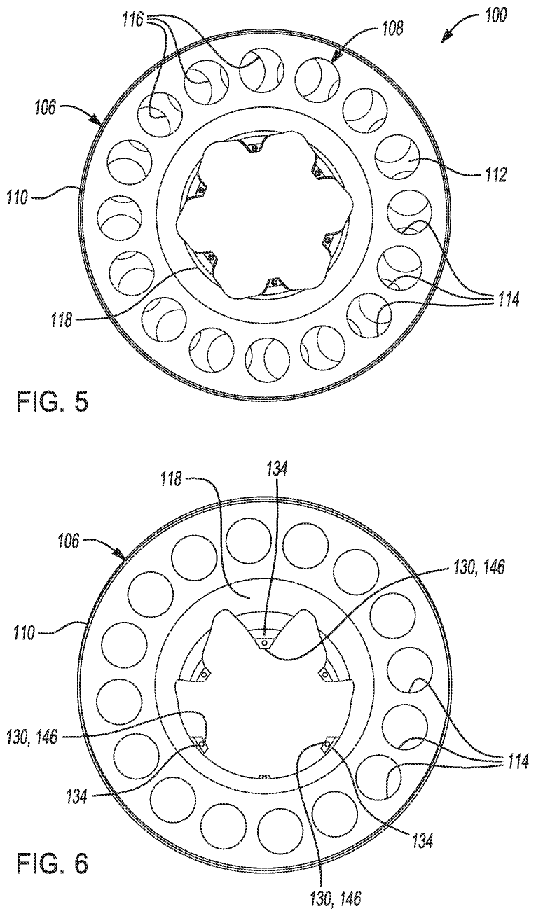

Referring to FIG. 1, one example of a three-dimensional (3D) printer 10 includes one or more canisters 12 each containing a split spool assembly 100 (FIG. 3) for storing a filament 104. The printer 10 further includes a filament drive system 14 that engages one or more filaments 104 from associated canisters 12 and draws those filaments from the same. While FIG. 1 illustrates the filament drive system 14 engaging one filament 104 dispensed from only one cannister, it is contemplated that the filament drive system 14 can engage two or more filaments dispensed from any one or more canisters 12. The printer 10 further includes an enclosure 16 that defines a chamber 18, and the printer 10 includes a hozzle 20 for receiving the filament 104 from the filament drive system 14, heating the filament 104, and moving within an XY plane to dispense the melted filament in the chamber 18. The printer 10 includes an XY all-linear motor system 22 for moving the hozzle within the XY plane to 3D print an item within the chamber 18. The printer 10 further includes a work surface 24 for supporting the item and a Z-motor system (not shown) for linearly moving the work surface along the Z-axis to facilitate with 3D printing the item. However, it is contemplated that either one or both of the hozzle 20 and the work surface can be movable in any suitable directions for 3D printing the item. The printer 10 further includes a controller 26 electrically coupled to the filament drive system 14, the XY drive system 22, the hozzle 20, and the Z-motor system for actuating the same to 3D print the item. It will be appreciated that the split spool assembly 100 (FIG. 3) can be used to dispense filament to any suitable 3D printer.

Referring to FIGS. 3 and 4, one example of a split spool assembly 100 is configured to rotate about an axis 102 for discharging the filament 104 (FIG. 3) from the cannister 12 to the filament drive system 14. As best shown in FIG. 4, the split spool assembly 100 includes first and second spool parts 106, 108 connected to one another. In this example, the first and second spool parts 106, 108 are identical to one another, and each one of the first and second spool parts 106, 108 is a single-piece aluminum sheet metal part formed from deep drawn metal stamping on the same die. However, it is contemplated that the first and second spool parts may not be identical to one another, and either one or both of the spool parts can be made of other materials formed by any suitable manufacturing process.

The first and second spool parts 106, 108 include associated first and second reel collars 110, 112 spaced from one another by a width W for storing a predetermined amount of filament 104 (FIG. 3) therebetween. For example, first and second reel collars 110, 112 may be spaced from one another by a width W that accommodates 15 kilograms of filament on the split spool assembly. However, it is contemplated that the first and second reel collars 110, 112 can be spaced from one another by other distances for storing more or less than 15 kg of filament therebetween. In addition, the first and second reel collars 110, 112 are angularly spaced from the axis 102. In this example, each of the first and second reel collars 110, 112 is angularly spaced ninety (90) degrees relative to the axis 102. However, it is contemplated that either one or both of the first and second reel collars 110, 112 can be angularly spaced more or less than ninety (90) degrees relative to the axis. Each of the first and second reel collars 110, 112 includes a plurality of apertures 114, 116 for reducing the weight of the split spool assembly 100 and providing passages for a flow of air to ventilate the filament.

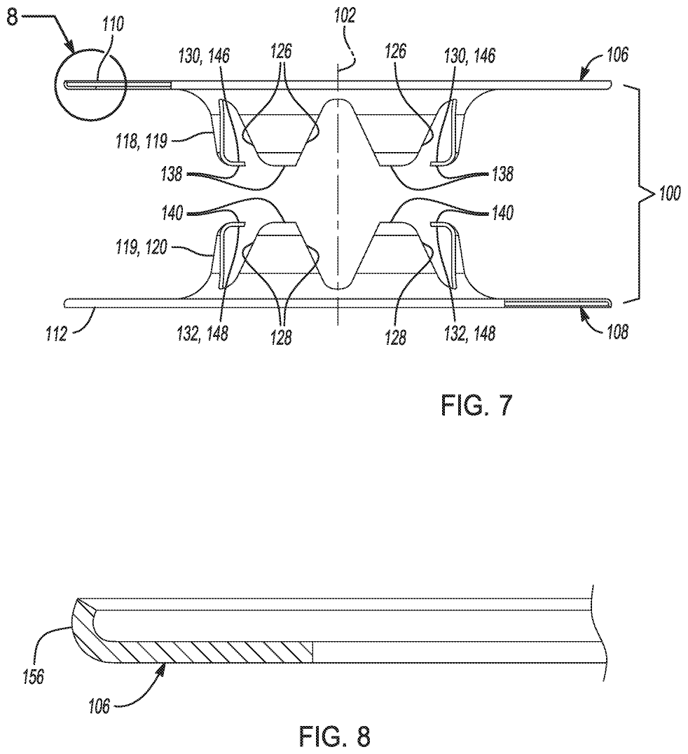

Referring to FIGS. 4 and 7, the first and second spool parts 106, 108 further include associated first and second hub portions 118, 120, which are disposed about the axis 102 and angularly spaced from the associated first and second reel collars 110, 112. Continuing with the previous example, the first and second hub portions 118, 120 can be drawn from the associated first and second reel collars 110, 112 in a stamping process. The draw angle may be ninety degrees to increase the amount of filament stored on the spool assembly, as compared to a lower draw angle. However, it is contemplated that the first and second hub portions can be formed by draw angles above or less than 90 degrees. Still in other examples, the first and second hub portions can be formed from other manufacturing processes. The first and second hub portions 118, 120 are disposed about the common axis 102 and terminate at associated first and second ends 122, 124. The first and second ends 122, 124 are positioned adjacent to one another, such that the first and second hub portions 118, 120 are arranged in series along the axis 102. The combined length of the first and second hub portions 118, 120 spaces the first and second reel collars from one another to provide the width (W) between the first and second reel collars for supporting filament wound around the first and second hub portions 118, 120.

As best shown in FIG. 7, the first and second hub portions 118, 120 define a plurality of openings 126, 128 or notches for providing clearance for the hub portions 118, 120 to be drawn from the associated first and second reel collars 110, 112. Continuing with the previous example, the openings 126, 128 can be configured to provide sufficient clearance for deeply drawing the first and second hub portions 118, 120 from the associated first and second reel collars 110, 112, which may increase the width W between the first and second reel collars 110, 112 and the associated capacity for storing filament 104 on the split spool assembly 100. More specifically, as best shown in FIG. 7, the openings 126, 128 form a saw-tooth profile 119 for the associated first and second hub portions 118, 120. Put another way, the size and number of openings may result in the first and second hub portions 118, 120 being formed from a plurality of tabs 123, 125 spaced from one another about the axis 102. Furthermore, the openings also reduce the weight of the split spool assembly 100 and ventilate the filament. It will be appreciated that the split spool assembly is reusable such that new filament can be loaded and wound around the split pool assembly after the original filament on the split spool assembly has been completely dispensed from same.

With continued reference to FIG. 7, the first and second hub portions 118, 120 terminate at one or more tip portions 130, 132 at an end of the hub portions 118, 120 opposite to the associated first and second reel collars 110, 112. In this example, the tip portions 130, 132 extend radially inward from the associated first and second hub portions 118, 120. However, in other examples, one or both of the first and second spool parts can have tip portions that extend radially outward from the axis or parallel with the axis. The tip portions 130 of the first hub portion 118 are connected to the associated tip portions 132 of the second hub portion 120, with half of the tip portions of each hub portion having threaded fasteners, such as swage nuts 134, attached thereto. More specifically, each tip portion 130 of the first hub portion 118 has an interfacing surface 138 for engaging an associated interfacing surface 140 of the second hub portion 120. In this example, each of the first and second hub portions 118, 120 includes six (6) tip portions 130, 132, and each tip portion 130, 132 defines a hole (not shown). Also, in this example, each tip portion 130, 132 has a distal surface 146, 148 opposite to the interfacing surface 138, 140, and half of the distal surfaces of the tip portions 130, 132 for each hub portion 118, 120 includes an associated one of three (3) swage nuts 134 mounted thereto. It is contemplated that the first and second hub portions can have more or fewer than six tip portions including more or fewer than three swage nuts or other fasteners. Furthermore, in other examples, the spool parts may not include separate threaded fasteners attached to the sheet metal, but rather the sheet metal can be pierce threaded such that the threaded fasteners are integral portions of the sheet metal.

Referring to FIGS. 7 and 8, at least one of the first and second reel collars 106, 108 has a rolled lip peripheral edge 156. This edge 156 can provide a smooth roller surface for feeding filament, and the rolled lip edge 156 can reinforce the associated reel collar. In this example, both of the first and second reel collars 106, 108 have a rolled lip peripheral edge 156. However, in other examples, it is contemplated that the only one or neither of the reel collars may have a rolled lip peripheral edge.

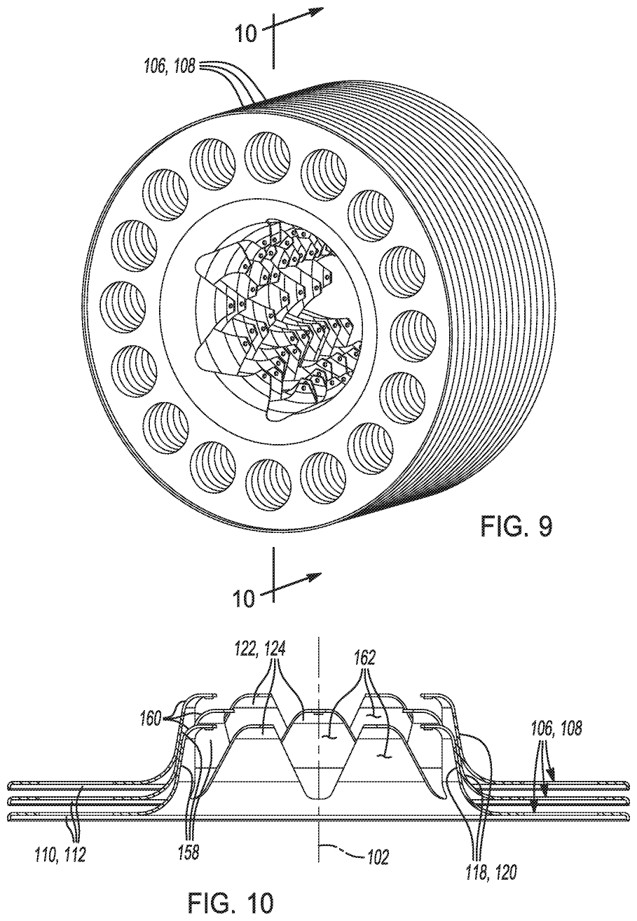

Referring to FIGS. 9 and 10, prior to joining the identical first and second spool parts 106, 108 for manufacturing the split spool assembly 100, two or more of the first and second spool parts 106, 108 can be nested within one another for compact storage or shipping of the spool parts. More specifically, as best shown in FIG. 10, each of the first and second hub portions 118, 120 has a frustoconical shape with an inner surface 158 facing the axis 102 and an outer surface 160 facing radially outward relative to the axis 102. The inner surface 158 defines a socket 162 having an inner diameter ID that tapers from the reel collar toward the ends 122, 124 of the associated first and second hub portions 118, 120, such that the stack of first and second spool parts 106, 108 are nested within one another with the socket 162 of the spool part receiving the outer surface 160 of the adjacent spool part.

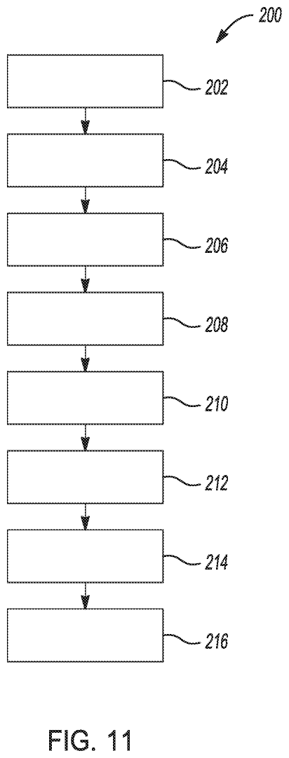

Referring to FIG. 11, a method 200 for manufacturing the split spool assembly 100 of FIG. 2 begins at block 202 with the step of providing a blank of sheet metal for cold forming in a stamping press machine. In this example, a roll of aluminum sheet metal can be fed into the stamping press machine, with a stamping die configured to form the first and second spool parts nested with one another on the sheet metal. It is contemplated that any other suitable manufacturing process may be used to manufacture the split spool assembly.

At block 204, the stamping press machine cuts the notches or openings 126, 128 in the sheet metal that are configured to provide clearance for the first and second hub portions 118, 120 to be drawn from the first and second reel collars 110, 112. In addition, the stamping press machine cuts the holes 126, 128 in the remaining sheet metal to form apertures for ventilating the filament wound around the first and second hub portions 118, 120 between the first and second reel collars 110, 112. Also, the press stamping machine may pierce the sheet metal to form the holes 142, 144 in the tip portions 130, 132.

At block 206, the stamping press machine draws the first and second hub portions 118, 120 from the sheet metal. In this example, the first and second hub portions 118, 120 are deeply drawn from the sheet metal by a depth greater than a diameter of the associated first and second reel collars 110, 112. However, it is contemplated that the first and second hub portions can be drawn from the sheet metal by a depth equal to or less than the diameter of the associated first and second reel collars.

At block 208, the stamping press machine forms the tip portions 130, 132 at the ends of the associated first and second hub portions 118, 120. The stamping press machine may form the tip portions 130, 132 to extend ninety (90) degrees from the first and second hub portions and radially inward toward the axis 102. However, it is contemplated that the tip portions can be formed to extend radially outward from the first and second hub portions or parallel with axis 102.

At block 210, the first and second spool parts are cut out and separated from the sheet metal.

At block 212, nuts are attached to half of the tip portions, on a side of the tip portions opposite to the other spool part. In this example, each of the first and second spool parts is formed with six (6) tip portions, and three (3) nuts are attached to every other tip portion by a swaging process. However, it is contemplated other fasteners can be mounted to the tip portions by other suitable manufacturing processes.

At block 214, the first and second spool parts 106, 108 are positioned such that the tip portions 130, 132 of the first and second spool parts are engaging one another while positioning only one swage nut at each pair of engaged tip portions.

At block 216, the first and second hub portions are connected to one another. Continuing with the previous example, a plurality of threaded fasteners 150, 152 are applied to the tip portions 130, 132 and the swage nuts 134, 136 for attaching the first and second spool parts 106, 108 to one another. In this example, three (3) screws 150 are inserted into holes 142 of the first spool part to threadably engage the three (3) associated swage nuts 136 attached to the second spool part 108, and three (3) other screws 152 are inserted into holes 144 of the second spool part 108 to threadably engage the three (3) associated swage nuts 134 attached to the first spool part 106.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A split spool assembly for discharging filament to a three-dimensional printer, the split spool assembly comprising:
a first spool part having a first reel collar angularly spaced from an axis and a first hub portion disposed about the axis and angularly spaced from the first reel collar;
a second spool part having a second reel collar angularly spaced from the axis and a second hub portion disposed about the axis and angularly spaced from the second reel collar;
wherein the first and second reel collars are spaced from one another by a width for storing a predetermined amount of filament therebetween;
wherein the first and second hub portions are disposed about the axis and terminate at associated first and second ends, with the first and second ends being positioned adjacent to one another such that the first and second hub portions are arranged in series along the axis and a combined length of the first and second hub portions provides the width between the first and second reel collars for supporting the filament wound around the first and second hub portions.

2. The split spool assembly of claim 1 wherein the first and second hub portions are drawn from the associated first and second reel collars.

3. The split spool assembly of claim 2 wherein each of the first and second reel collars is positioned ninety degrees relative to the axis.

4. The split spool assembly of claim 1 wherein each of the first and second reel collars defines a plurality of apertures.

5. The split spool assembly of claim 1 wherein each of the first and second hub portions define a plurality of openings for providing clearance for the first and second hub portions to be drawn from the associated first and second reel collars.

6. The split spool assembly of claim 1 wherein the plurality of openings form a saw tooth profile for each of the first and second hub portions.

7. The split spool assembly of claim 1 wherein each of the first and second hub portions comprises a plurality of tabs annularly spaced from one another about the axis.

8. The split spool assembly of claim 1 wherein the first and second spool parts further comprise a plurality of tip portions disposed at an end of the first and second hub portions opposite to the associated first and second reel collars, and the tip portions extend radially inward from the first and second hub portions.

9. The split spool assembly of claim 8 wherein the tip portions of the first hub portion are connected to the associated tip portions of the second hub portion.

10. The split spool assembly of claim 9 further comprising a plurality of threaded fasteners connected to half of the tip portions of the first hub portion and half of the tip portions of the second hub portion.

11. The split spool assembly of claim 9 wherein each of the tip portions has an interfacing surface, where the interfacing surfaces of the tip portions for the first hub portion engage with the associated interfacing surfaces of the tip portions for the second hub portion.

12. The split spool assembly of claim 9 wherein the tip portions have a plurality of distal surfaces opposite to the interfacing surfaces and half of the distal surfaces for each of the first and second hub portions includes an associated one of the threaded fasteners.

13. The split spool assembly of claim 1 wherein at least one of the first and second reel collars has a rolled lip peripheral edge.

14. The split spool assembly of claim 1 wherein the first and second spool parts are identical to one another and configured to nest within one another

15. The split spool assembly of claim 14 wherein each of the first and second hub portions have a frustoconical shape with an inner surface facing the axis and an outer surface facing radially outward relative to the axis, such that the inner surface defines a socket having an inner diameter tapering from the associated first and second reel collars to the first and second ends, and the socket of one of the first and second spool parts receiving the hub portion of the other of the second and second spool parts.

16. A three-dimensional printer comprising:
an enclosure defining a chamber;
a work surface disposed within the chamber;
a hozzle for melting and dispensing a filament within the chamber;
at least one cannister containing a split spool assembly for storing the filament;
a filament drive system for engaging the filament and drawing the filament from the at least one cannister, with the hozzle receiving the filament from the filament drive system;
wherein the split spool assembly comprises:
a first spool part having a first reel collar angularly spaced from an axis and a first hub portion disposed about the axis and angularly spaced from the first reel collar;
a second spool part having a second reel collar angularly spaced from the axis and a second hub portion disposed about the axis and angularly spaced from the second reel collar;
wherein the first and second reel collars are spaced from one another by a width for storing a predetermined amount of filament therebetween;
wherein the first and second hub portions are disposed about the axis and terminate at associated first and second ends, with the first and second ends being positioned adjacent to one another such that the first and second hub portions are arranged in series along the axis and a combined length of the first and second hub portions provides the width between the first and second reel collars for supporting the filament wound around the first and second hub portions.

17. The three-dimensional printer of claim 16 wherein the first and second hub portions are drawn from the associated first and second reel collars.

18. A method for manufacturing a split spool assembly including first and second spool parts, with the first and second spool parts having associated first and second reel collars angularly spaced from an axis and first and second hub portions disposed about the axis, the method comprising:
placing a flat sheet metal into a stamping press;
drawing the first and second hub portions from the sheet metal;
cutting the first and second reel collars from the flat sheet metal;
positioning the first and second hub portions adjacent to one another such that the first and second hub portions are arranged in series along the axis and a combined length of the first and second hub portions provides a width between the first and second reel collars;
connecting the first and second hub portions to one another; and
winding filament around the first and second hub portions.

19. The method of claim 18 further comprising deep drawing the first and second hub portions from the sheet metal, such that the first and second hub portions are drawn a depth greater than a diameter of the associated first and second reel collars.

20. The method of claim 19 further comprising cutting, using the stamping press machine, a plurality of openings into the first and second hub portions to define a saw tooth profile for each of the first and second hub portions.
